(19) United States
(12) Patent Application Publication
(10) Pub. No.: US 2010/0247229 A1
(43) Pub. Date: Sep. 30, 2010

(54) END RING FOR A VEHICULAR ELECTRIC MACHINE

(75) Inventors: EDWARD L. KAISER, ORION, MI (US); PETER BOSTWICK, ROCHESTER, MI (US); MATTHEW D. LABA, OAKLAND, MI (US); RICHARD W. ROBERTSON, JR., WYANDOTTE, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/415,646

(22) Filed: Mar. 31, 2009

(51) Int. Cl. F16B 9/00

(52) U.S. Cl. 403/14

(57) ABSTRACT

An end ring for a rotor assembly in a vehicular electric machine is provided, wherein the rotor assembly has a first end and is configured to rotate on a shaft. The end ring comprises an annulus circumscribing the shaft and engaging the end of the rotor assembly, and a sleeve coupled to the annulus and circumferentially coupled to the shaft.

### TECHNICAL FIELD

The present invention generally relates to vehicular electric machines, and more particularly relates to an end ring for a vehicular electric machine.

### BACKGROUND OF THE INVENTION

In recent years, advances in technology have led to substantial changes in the design of automobiles. One of these changes involves the complexity, as well as the power usage of various electrical systems within automobiles, particularly those within alternative fuel vehicles. For example, alternative fuel vehicles such as hybrid vehicles often use electrochemical power sources, such as batteries, ultracapacitors, and fuel cells, to power the electric traction machines (or motors) that drive the wheels, sometimes in addition to another power source, such as an internal combustion engine.

Such electric traction machines typically include an annular rotor assembly that rotates axially on a shaft or hub within a stationary stator assembly. The rotor assemblies are configured to generate magnetic flux either inductively by using electromagnets or, in the case of an internal permanent magnet machine (IPM), by using a multitude of permanent magnets arrayed within a central magnetic core. To retain the permanent magnets axially within the central magnetic core, end rings are mounted on the shaft or hub at the end of the rotor core. To prevent shorting of the magnetic flux from the core region of an IPM, the end rings are fabricated from a low permeability, non magnetic material such as stainless steel or aluminum. Such end rings typically have a planar, annular, disc-like geometry, and are often fabricated from powdered metals using a sintering process or machined from a blank. Prior to installation on the shaft, the rings are machined over a significant portion of their surface area to remove surface roughness and achieve desired features. In addition, because end rings are typically mounted onto shafts using a friction mount, further precise machining of the inner circumference of the ring is also important to ensuring a tight and secure fit suitable for operation at high rates of rotation.

Accordingly, it is desirable to provide an end ring for a vehicular electric machine that requires less finish machining and is fabricated from lower cost, lighter weight materials. It is also desirable if such an end ring has greater stiffness and rigidity and is configured for improved retention of bonded permanent magnets. Further, for hub-mounted rotor assemblies, it is also desirable if the end ring provides increased protection from magnetic flux shorting while enhancing coolant flow between the rotor and the hub without increased ring weight. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

In accordance with an embodiment, by way of example only, an end ring for a rotor assembly in a vehicular electric machine is provided. The rotor assembly has a first end and is configured to rotate on a shaft. The end ring comprises an annulus circumscribing the shaft and engaging the first end of the rotor assembly, and a sleeve coupled to the annulus and circumferentially coupled to the shaft.

In accordance with another embodiment, by way of example only an end ring of a type suitable for deployment in a vehicular electric machine is provided. The electric machine has a rotor assembly configured to rotate with a hub assembly, the hub assembly including a sleeve portion about which the rotor assembly is circumscribed and including a flange having a first surface and extending radially outward from an end of the sleeve portion. The end ring comprises an annular ring having a second surface configured to reside adjacent the first surface and having a third surface configured to reside adjacent an end of the rotor assembly, and a first protrusion extending from the second surface and configured to engage the first surface so as to separate the first surface from the second surface.

### DESCRIPTION OF THE DRAWINGS

A more complete understanding of the present invention may be derived by referring to the detailed description and claims when considered in conjunction with the following figures, wherein like reference numbers refer to similar elements throughout the figures, and

FIG. 1 is a schematic diagram of an exemplary vehicle illustrating a manner in which an embodiment is integrated with various sub-components of the vehicle;

FIG. 2 is a schematic cross-sectional diagram, illustrating an exemplary vehicular motor for use with the vehicle depicted in FIG. 1, and having an integrated end ring in accordance with an exemplary embodiment;

FIG. 3 is a schematic cross-sectional diagram of a portion of the vehicular motor depicted in FIG. 2, magnified to more clearly illustrate the end ring in accordance with an exemplary embodiment;

FIG. 4 is an isometric view of an exemplary end ring of the type depicted in FIGS. 2 and 3;

FIG. 5 is an isometric view of portions of an exemplary hub assembly having an end ring in accordance with a further exemplary embodiment; and

FIG. 6 is a schematic cross-sectional diagram illustrating a portion of an electric machine having a hub assembly of the type illustrated in FIG. 5, and having an end ring in accordance with another embodiment.

### DESCRIPTION OF AN EXEMPLARY EMBODIMENT

The various embodiments of the present invention described herein provide an end ring for a rotor assembly of an electric machine suitable for deployment on a vehicle. The electric machine may be, for example, an internal permanent magnet machine and may comprise an electric generator or an electric motor, or a combination of these (motor/generator). The end ring is stamped from a single layer of a low magnetic permeability metal made from rolled metal sheet. The end ring is also configured with features that facilitate assembly procedures and enhance machine performance and efficiency during operation. These features, described in detail below, result in reduced shorting of magnetic flux, increased stiffness, enhanced coolant flow, a more secure retention for permanent magnets during bonding to the rotor core, alignment indexing of the end ring to the rotor core to facilitate assembly, and improved coupling between the end ring and the shaft or hub to enhance reliability when operating at elevated temperatures and high rates of rotation.

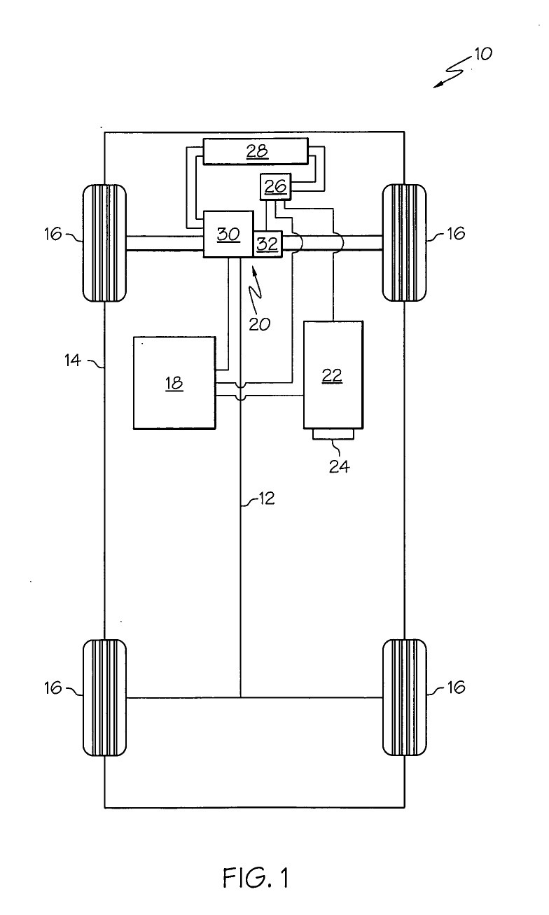

FIG. 1 is a schematic diagram of an exemplary vehicle 10, such as an automobile, according to one embodiment of the present invention. The automobile 10 includes a chassis 12, a body 14, four wheels 16, and an electronic control system (or electronic control unit (ECU)) 18. The body 14 is arranged on the chassis 12 and substantially encloses the other components of the automobile 10. The body 14 and the chassis 12 may jointly form a frame. The wheels 16 are each rotationally coupled to the chassis 12 near a respective corner of the body 14.

The automobile 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). The automobile 10 may also incorporate any one of, or combination of, a number of different types of engines (or actuators), such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, or a fuel cell, a combustion/electric motor hybrid engine, and an electric motor.

In the exemplary embodiment illustrated in FIG. 1, the automobile 10 is a fuel cell vehicle, and further includes an actuator assembly (or powertrain) 20, a battery 22, a battery state of charge (SOC) system 24, a power electronics bay (PEB) 26, and a radiator 28. The actuator assembly 20 includes an internal combustion engine 30 and an electric motor/generator (or electric traction machine) system (or assembly) 32. The battery 22 is electrically coupled to PEB 26 and, in one embodiment, comprises a lithium ion (Li-ion) battery including a plurality of cells, as is commonly used. Electric traction machine 32 typically comprises a plurality of electric components, including stator and rotor assemblies. The rotor assembly includes at least one end ring stamped from a sheet of a low magnetic permeability material to provide retention of magnets in this assembly, and having additional features that enhance machine performance and efficiency, and facilitate assembly during fabrication.

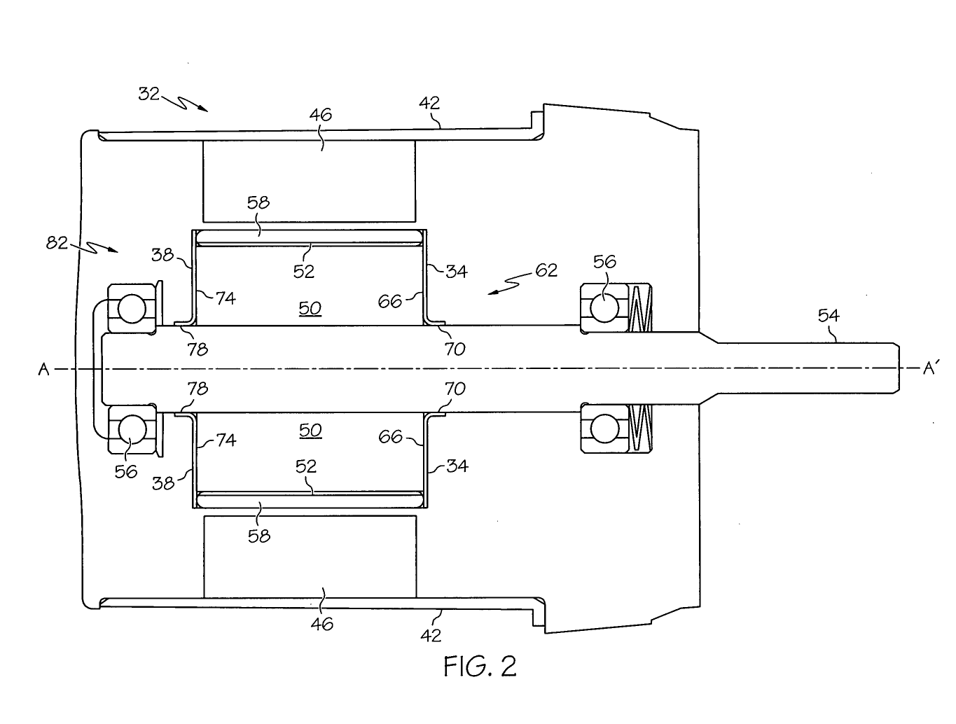

FIG. 2 is a schematic cross-sectional diagram illustrating an electric machine assembly 32 having integrated first and second end rings 34 and 38, respectively, in accordance with an exemplary embodiment. It should be noted that many detailed elements commonly found in such an electric machine have been omitted for greater clarity. Assembly 32 includes a housing 42, a stator assembly 46, and a rotor assembly 50. Stator assembly 46 is contained within and fixedly coupled to housing 42. Rotor assembly 50 includes a rotor core 52, and is rotatably coupled to stator 46, and rotates substantially concentrically thereto on a shaft 54 that rotates on an axis A-A′. Bearings 56 are coupled to housing 42 proximate either end thereof, and provide support for, and rotatable coupling to, shaft 54. Rotor assembly 50 also includes a magnet array 58 that may have any number of individual permanent magnets bonded into slots in the outer surface of rotor core 52. Permanent magnet array 58 is configured to generate magnetic flux that interacts with electromagnetic flux generated by stator assembly 46 to apply a torque to rotor assembly 50 causing assembly 50 to rotate in a well known manner. First end ring 34 is coupled to a first end 62 of assembly 50, and includes a first annular ring (or annulus) 66 coupled to a first sleeve 70.

In one embodiment, first annulus 66 and first sleeve 70 are integrally joined together. As used herein, the term “integrally joined” or “integrally formed” means that a first element, (such as first annulus 66) extends or transitions in a continuous manner from a second element, (such as first sleeve 70) and not as two separate and distinguishable elements. First sleeve 70 is mounted substantially concentrically to the outer surface of shaft 54 by, for example, press/interference fitting. First annulus 66 has an inner face that engages the end of rotor assembly 50 adjacent to an end of magnet array 58. First annulus 66 comprises a low magnetic permeability material and provides axial (along any line substantially parallel to axis A-A′) retention to magnet array 58 containing magnetic flux generated by these magnets within rotor assembly 50, and improving the efficiency of electric machine assembly 32 thereby. Second end ring 38 is also fabricated from a suitable low magnetic permeability metal and is configured similarly to first end ring 34, and includes a second annulus 74 integrally joined to a second sleeve 78. Second annulus 74 is configured to provide axial retention to magnets disposed proximate a second end 82 of rotor assembly 50, and second sleeve 78 mounts by interference fit circumferentially to shaft 54.

During operation, rotor assembly 50 rotates with shaft 54 about axis A-A′ substantially concentrically within stator assembly 46 generating mechanical energy thereby. End rings 34 and 38 rotate with rotor assembly 50, each ring providing axial retention to magnet array 58, and containing magnetic flux generated by these magnets within rotor assembly 50. As will be described in detail below, first and second sleeves 70 and 78 provide end rings 34 and 38, respectively, with secure coupling to shaft 54 even at elevated operating temperatures and high rates of rotation.

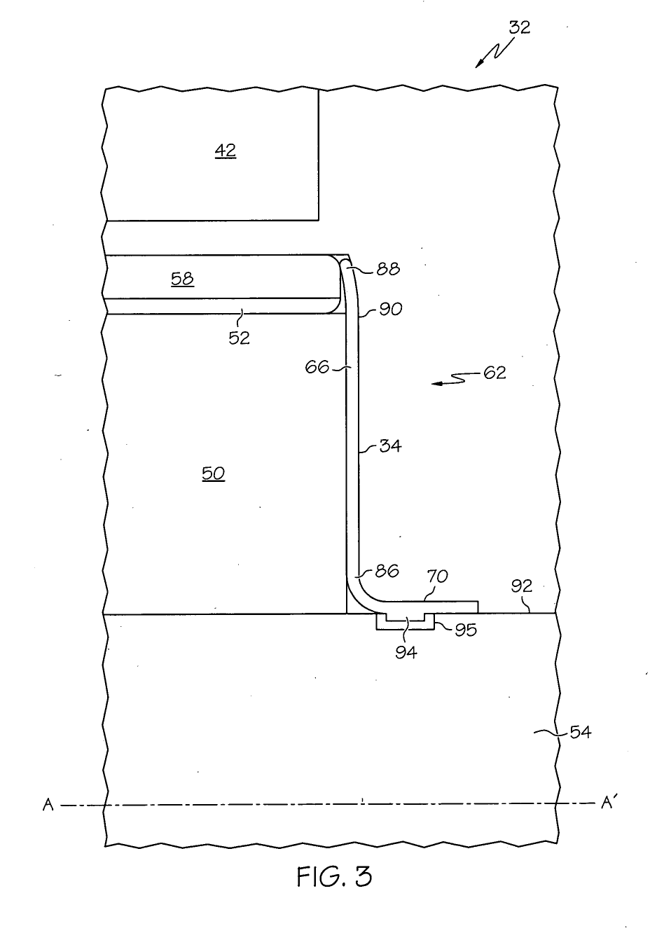

FIG. 3 is a schematic cross-sectional diagram illustrating a portion of electric machine assembly 32 magnified to more clearly show the integration of end ring 34 therein, in accordance with the exemplary embodiment. First end ring 34 includes first annulus 66 and first sleeve 70 coupled together at an inner circumferential edge 86 of annulus 66, and a retention tab 88 coupled to at an outer circumferential edge 90 of annulus 66. First annulus 66 circumscribes shaft 54 and is coupled to and engages the first end 62 of rotor assembly 50. In one embodiment, first annulus 66 is integrally formed with first sleeve 70. In another embodiment, retention tab 88 is somewhat angled toward the permanent magnets in array 58, and is configured to apply resilient force to these magnets. In yet another embodiment, annulus 66 is angled slightly toward rotor assembly 50 as a further means of providing resilient force to magnet array 58. Such resilient force generated by either or both of annulus 66 and retention tab 88 may be used as a means of axially centering or locating the magnets in array 58 during bonding to rotor core 52.

First sleeve 70 is press/interference fit circumferentially over the outer cylindrical surface 92 of shaft 54, and is non-planar with first annulus 66. First sleeve 70 may extend away from annulus 66 along shaft 54 by any suitable distance without limitation. In one embodiment, sleeve 70 assumes the form of a flaring of inner circumferential edge 86. In another embodiment, sleeve 70 is tapered having a diameter that decreases with distance away from annulus 66 to facilitate mounting and interference fitting onto shaft 54. Such an interference mount in conjunction with the increased circumferential contact of a sleeve design helps to provide a more secure fit at elevated temperatures and high rotation speeds. In a further embodiment, sleeve 70 also includes a tab 94 configured to engage a keyway or groove 95 machined into surface 92 of shaft 54. Tab 94 provides additional rotational support to end ring 34 preventing sleeve 70 from rotating with respect to shaft 54 including during operation at elevated temperatures.

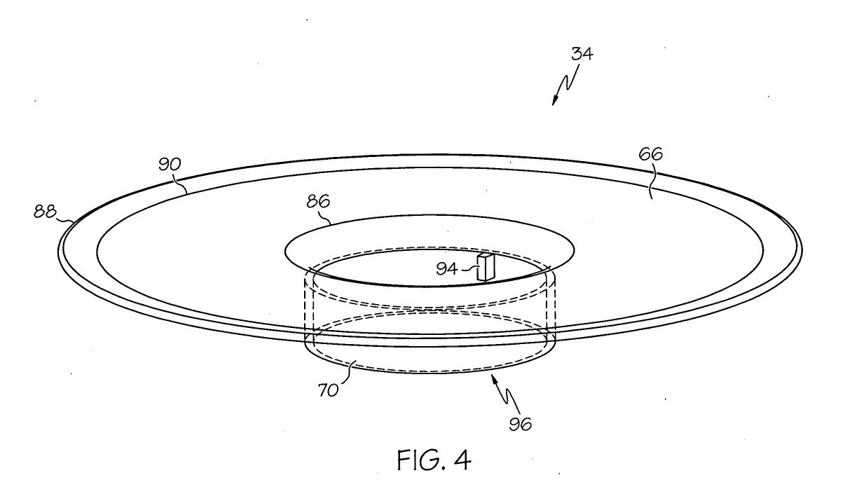

FIG. 4 is an isometric view of first end ring 34 in accordance with an exemplary embodiment. Ring 34 is fabricated from any suitable metal or metal alloy sheet having a low magnetic permeability composition. In one embodiment, ring 34 is fabricated from a sheet metal material having a magnetic permeability of from about 1 to about 2 times the magnetic permeability of a vacuum. Suitable sheet metals for ring 34 include, for example, titanium, aluminum, stainless steel, copper, magnesium, chromium, zinc, manganese, molybdenum, and alloys thereof Ring 34 includes sleeve 70 integrally formed with annulus 66 at an inner circumferential edge 86 thereof Sleeve 70 forms an opening 96 therethrough suitably sized to be interference fit to shaft 54 (FIG. 3). Sleeve 70 includes tab 94 configured to engage a keyway 95 (FIG. 3) in the surface of shaft 54 and prevent sleeve 70 from rotating with respect to shaft 54. Retention tab 88 is integrally formed at an outer circumferential edge 90 of annulus 66, and is configured to provide resilient retentive force to the individual magnets of magnet array 58 during bonding to rotor assembly 50 (FIG. 3). In one embodiment, tab 88 assumes the form of a finger-like projection integrally formed with outer circumferential edge 90 and extending therefrom.

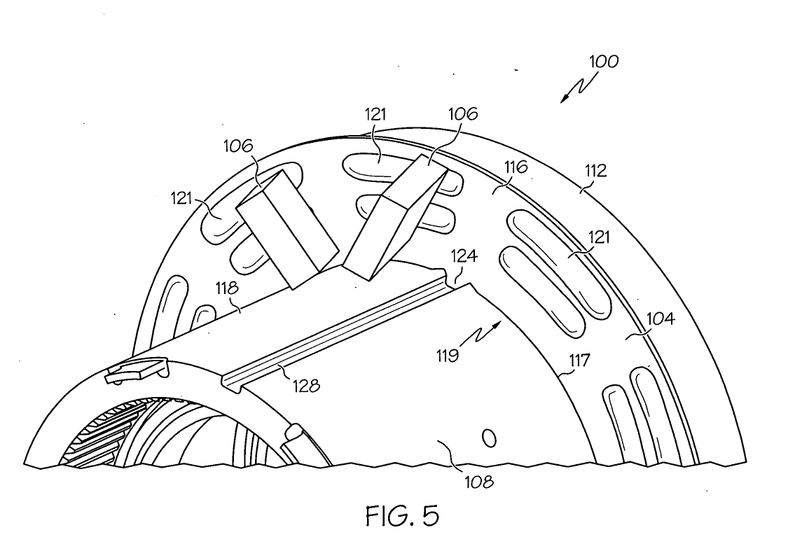

FIG. 5 is an isometric view of portions of a hub assembly 100 suitable for deployment in an electric machine and having an end ring 104, in accordance with another exemplary embodiment. Certain elements generally associated with such a hub assembly such as an annular rotor lamination core have been omitted for greater clarity. Individual permanent magnets 106 which are typically integrated within the rotor lamination core are illustrated to show the interaction between these magnets and other elements of assembly 100. Hub assembly 100 includes a sleeve portion 108 coupled to and configured to rotate with a flange portion 112. Flange portion 112 is coupled to and configured to rotate on suitable bearings (not shown). End ring 104 includes an annular ring 116 having an inner circumferential edge 117 coupled to an outer cylindrical surface 118 of sleeve portion 108 proximate an end 119 thereof. Annular ring 116 has a plurality of protrusions 121 integrally formed therein. In one embodiment, protrusions 121 are directed outwardly away from magnets 106 and toward flange portion 112 and increasing the separation therebetween. Such an increased separation provides an air gap between annular ring 116 and flange portion 112 that reduces the permeability of magnetic flux between flange portion 112 and permanent magnets 106 overlying sleeve portion 108. Protrusions 121 enable such supplemental shielding without increased thickness and weight/inertia of annular ring 116. In another embodiment, protrusions 121 are configured to engage magnets 106 and provide support and retention to magnets 106 while these magnets are being bonded to the rotor core. In another embodiment, protrusions 121 are interrupted or discontinuous from each other providing a pathway for coolant flow between flange portion 112 and annular ring 116. In a further embodiment, protrusions 121 are configured to increase the stiffness/rigidity of annular ring 116, enabling additional resilient retentive force to individual magnets.

Referring to FIG. 5, in another embodiment, annular ring 116 has an indexing tab 124 configured to engage with a groove or keyway 128 in outer cylindrical surface 118. Tab 124 and keyway 128 may have any suitable shape that helps to rotationally align end ring 104 to sleeve portion 108 during assembly for any purpose such as to align magnets to protrusions 121. Those of skill in the art will appreciate that these structures may be reversed such that the tab resides in outer surface 118, and the keyway as a feature of annular ring 116.

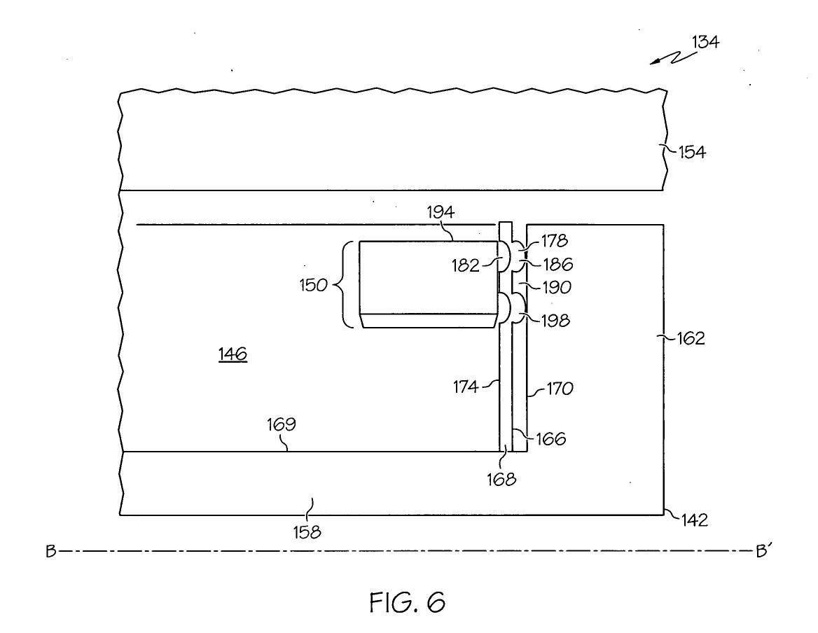

FIG. 6 is a schematic diagram illustrating in cross-section a portion of an electric machine 134 having a hub assembly of the type illustrated in FIG. 5, and having an end ring 138 in accordance with another embodiment. Electric machine 134 includes a hub assembly 142, a rotor assembly lamination core 146, a magnet array 150, and a stator assembly 154. Hub assembly 142 is rotatably coupled to and rotates within stator assembly 154, and includes a sleeve portion 158, and a flange portion 162 coupled to an end of sleeve portion 158. Rotor lamination core 146 is circumferentially coupled to and configured to rotate with sleeve portion 158 on an axis of rotation B-B′. Magnet array 150 may have any number of individual permanent magnets, and is coupled to rotor lamination core 146, and rotates therewith. An annular end ring 166 is interposed between an end 170 of flange portion 162, and an end 174 of rotor lamination core 146. Ring 166 has an inner circumferential edge 168 circumferentially coupled to an outer cylindrical surface 169 of sleeve portion 158. End ring 166 may be made from any suitable low magnetic permeability sheet metal of any of the compositions previously described with reference to end ring 34, and illustrated in FIG. 4. End ring 166 separates flange portion end 170 from lamination core end 174, and provides magnetic shielding between magnet array 150 and flange portion 162, thereby preventing shorting of magnetic flux therebetween.

In one embodiment, end ring 166 includes at least a first protrusion 178 on a side adjacent the flange portion end 170, and having a cavity 182 on a side adjacent magnet array 150. Protrusion 178 is configured to separate flange portion end 170 from magnet array 150 and lamination core 146 by creating an air gap 190 that increases the magnetic shielding of end ring 166. In another embodiment, cavity 182 engages with a first magnet 194 of magnet array 150 providing axial (along any line substantially parallel to rotational axis B-B′) retention thereto. While end ring 166 is shown in FIG. 6 as having two protrusions, it is understood that ring 166 may comprise any number of such protrusions. In another embodiment, end ring 166 includes at least a second protrusion 198 separated from first protrusion 178 so as to create a continuous pathway therebetween for the flow of a coolant within electric machine 134. These protrusions may also impart greater stiffness to end ring 166 to provide greater rigidity and improved axial retention to individual magnets in magnet array 150.

The various embodiments of the present invention described herein provide an end ring for a vehicular electric machine. The end ring includes an annular ring (or annulus) configured to retain permanent magnets axially within the magnet array of an IPM. The annular ring may be coupled to a hub assembly or to a motor shaft. In the case of a hub assembly, the annular ring is coupled to a cylindrical mounting surface within the assembly. When shaft-mounted, the annular ring is coupled to a sleeve configured for interference mounting to the outer surface of the shaft. The end ring is fabricated from high mechanical strength, low magnetic permeability rolled sheet metal which reduces the need for surface finishing, thereby reducing material and machining expense. In various embodiments, the annular ring and sleeve (if used) have additional features for enhancing performance and facilitating machine assembly. Features associated with the annular ring include an indexing tab configured to engage with a keyway in the hub core to aid with core/end ring alignment during assembly. The annular ring may also have protrusions/cavities configured for various performance enhancing functions including: 1) providing additional spacing between permanent magnets and the hub end without adding weight to the ring, 2) adding rigidity to the annular ring for enhanced resilient retention of permanent magnets, 3) providing a coolant flow passage between the hub and annular ring. The annular ring may also have integrally formed tabs configured to retain individual permanent magnets during bonding to the rotor core. The sleeve is configured for a more secure mount to the shaft and may include tapering to suit this purpose. The sleeve may also include a tab configured to engage with a shaft keyway to prevent slippage at elevated temperatures and high rates of rotation.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention and the legal equivalents thereof.

What is claimed is:

1. An end ring for a rotor assembly in a vehicular electric machine, the rotor assembly having a first end and configured to rotate on a shaft, the end ring comprising:
an annulus circumscribing the shaft and engaging the first end of the rotor assembly; and
a sleeve coupled to the annulus and circumferentially coupled to the shaft.

2. An end ring according to claim 1, wherein the rotor assembly further comprises a magnet coupled to the first end of the rotor assembly, and further comprising a first tab coupled to an outer circumferential edge of the annulus, the first tab configured to retain the magnet.

3. An end ring according to claim 2, wherein the first tab is integrally formed with the outer circumferential edge of the annulus.

4. An end ring according to claim 2, wherein the annulus is angled toward the rotor assembly to provide resilient retentive force to the magnet.

5. An end ring according to claim 1, wherein the sleeve is configured to be interference fitted onto the shaft.

6. An end ring according to claim 5, wherein the sleeve is tapered.

7. An end ring according to claim 1, wherein the shaft comprises a keyway, and wherein the end ring further comprises a second tab coupled to the sleeve, the second tab configured to engage the keyway of the shaft.

8. An end ring according to claim 1, wherein the end ring comprises a sheet metal material having a magnetic permeability of from about 1 to about 2 times the magnetic permeability of a vacuum.

9. An end ring according to claim 1, wherein the end ring has a composition selected from a group consisting of titanium, aluminum, stainless steel, copper, magnesium, chromium, zinc, manganese, molybdenum, and alloys thereof.

10. An end ring of a type suitable for deployment in a vehicular electric machine having a rotor assembly configured to rotate with a hub assembly, the hub assembly including a sleeve portion about which the rotor assembly is circumscribed and including a flange having a first surface and extending radially outward from an end of the sleeve portion, the end ring comprising:
an annular ring having a second surface configured to reside adjacent the first surface and having a third surface configured to reside adjacent an end of the rotor assembly; and
a first protrusion extending from the second surface and configured to engage the first surface so as to separate the first surface from the second surface.

11. An end ring according to claim 10, further comprising a second protrusion extending from the second surface of the annular ring, the first and second protrusions configured to provide a coolant flow pathway between the first and second surfaces.

12. An end ring according to claim 10, wherein a magnet is coupled to the rotor assembly proximate the end thereof, and wherein the end ring further comprises a cavity in the third surface of the annular ring configured to retain the magnet.

13. An end ring according to claim 12, further comprising:
a keyway disposed in an outer surface of the sleeve; and
a tab coupled to an inner circumferential edge of the annular ring and configured to engage the keyway and align the cavity with the magnet.

14. An end ring according to claim 10, wherein the annular ring comprises a sheet metal having a magnetic permeability of from about 1 to about 2 times the magnetic permeability of a vacuum.

15. An end ring according to claim 14, wherein the annular ring comprises stainless steel sheet.

16. An end ring for a rotor assembly of the type deployable in a vehicular electric machine, the rotor assembly having an end and configured to rotate on a shaft and having a magnet coupled proximate the end, the end ring comprising:
an annular ring circumscribing the shaft and engaging the end of the rotor assembly;
a first tab coupled to an outer circumferential edge of the annular ring and configured to retain the magnet; and
a sleeve portion integrally formed with the annular ring, and circumscribed about and coupled to the shaft.

17. An end ring according to claim 16, wherein the shaft further comprises a groove, and wherein the end ring further comprises a second tab coupled to the sleeve portion and configured to engage the groove.

18. An end ring according to claim 16, wherein the sleeve portion is interference fitted onto the shaft.

19. An end ring according to claim 18, wherein the sleeve portion is tapered.

20. An end ring according to claim 16, wherein the sleeve portion is configured as a flaring of an inner circumferential edge of the annular ring.
